(19) United States
(12) Patent Application Publication
(10) Pub. No.: US 2012/0051269 A1
(43) Pub. Date: Mar. 1, 2012

(54) INTERNET PROTOCOL PHONE AND CONFERENCE CALL ESTABLISHING METHOD

(75) Inventor: LIAN-DONG LIU, Tu-Cheng (TW)

(73) Assignee: HON HAI PRECISION INDUSTRY CO., LTD., Tu-Cheng (TW)

(21) Appl. No.: 13/009,768

(22) Filed: Jan. 19, 2011

(30) Foreign Application Priority Data
Aug. 26, 2010 (CN) 201010263705.4

(51) Int. Cl. H04L 12/18

(52) U.S. Cl. 370/261

(57) ABSTRACT

An internet protocol (IP) phone establishes a conference call with a plurality of other IP phones until the IP phone has no available audio mixing capacity. The IP phone selects one of the other IP phones having available audio mixing capacity in the conference call when a new IP phone is to join the conference call but the IP phone has no available audio mixing capacity. The IP phone further transmits a selection message to the selected one of the other IP phones to make the selected one of the other IP phones to mix audio line of the new IP phone to accept the new IP phone joining the conference call.

### BACKGROUND

1. Technical Field

Embodiments of the present disclosure relate to Internet protocol (IP) phones, and more particularly to a conference call establishing method of an IP phone.

2. Description of Related Art

Generally, IP phones have an audio mixing capability used to establish conference call. However, the audio mixing capacity of an IP phone is very limited. For example, a caller IP phone supporting a 3-party conference call can communicate with other at most two callee IP phones. Upon the condition of a four-party conference being required, the caller IP phone has no extra mixing resources to accept a new callee IP phone joining the four-party conference.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment of one embodiment of IP phones of the present disclosure;

FIG. 2 is a schematic diagram of functional modules of one embodiment of the IP phones of FIG. 1;

FIG. 3 is a schematic diagram of an example application environment of the IP phones of FIG. 2.

FIG. 4 is a flowchart of one embodiment of a conference call establishing method of the present disclosure;

FIG. 5 is a flowchart of one embodiment of step S404 of selecting one of the callee IP phones having available audio mixing capacity of FIG. 4; and

FIG. 6 is a flowchart of another embodiment of step S404 of the caller IP phone selecting one of the callee IP phones having available audio mixing capacity of FIG. 4.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

It should be understood that audio mixing, when applied to IP telephony, is the process of communication between two or more IP phones. The determination of how many audio lines (generally speaking, one IP phone is one line) can be mixed by an IP phone is limited to hardware and/or software resource of the IP phone. For example, if an IP phone can support a 3-party conference at most, then the IP phone can mix audio of two lines at most. Hereafter, the capacity of an IP phone(s) to mix audio of multiple lines to establish a conference call is called “audio mixing capacity” for simplicity.

Furthermore, if the IP phone can mix audio for more lines, then the IP phone has available audio mixing capacity. Similarly, if the IP phone cannot mix audio for any more lines, then the IP phone has no available audio mixing capacity. For example, if an IP phone can mix audio of two lines at most, and if the IP phone has already mixed audio of two lines to two other IP phones, then the IP phone has no available audio mixing capacity. If the IP phone has mixed audio of one line to another IP phone, then the IP phone has available audio mixing capacity and further can mix audio of one line to a third IP phone.

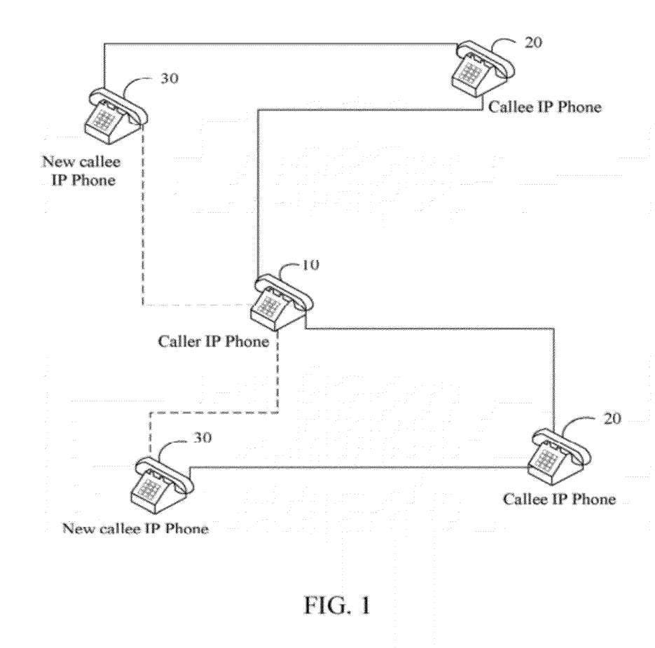

FIG. 1 is a schematic diagram of an application environment of one embodiment of Internet protocol (IP) phones of the present disclosure. The IP phones include a caller IP phone 10 which calls other IP phones to establish a conference call, a plurality of callee IP phones 20 which answers the call from the caller IP phone 10, at least one new callee IP phone 30 which is to join the conference call. It should be noted that, the caller IP phone 10, the callee IP phone 20, and the new callee IP phone 30 can have the same structure, although labelled differently for a clearer description.

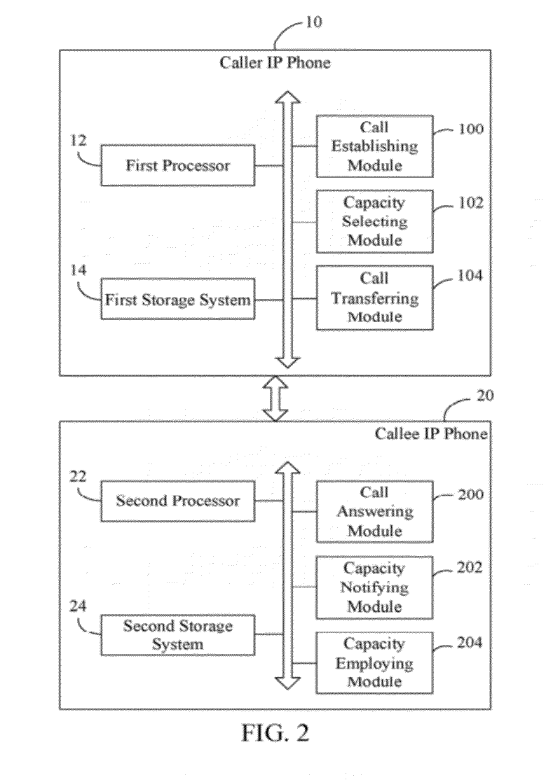

FIG. 2 is a schematic diagram of functional modules of one embodiment of the caller IP phone 10 and the callee IP phone 20 of FIG. 1. In one embodiment, the caller IP phone includes a first processor 12, a first storage system 14, a call establishing module 100, a capacity selecting module 102, a call transferring module 104, and a capacity responding module 106. The call establishing module 100, the capacity selecting module 102, and the call transferring module 104. Those modules may include one or more programs comprising computerized code that are stored in the first storage system 14 and executed by the first processor 12.

The callee IP phone 20 includes a second processor 22, a second storage system 24, a call answering module 200, a capacity notifying module 202, and a capacity employing module 204. Those modules may include one or more programs comprising computerized code that are stored in the second storage system 24 and executed by the second processor 22. It is should be noted that, the caller IP phone 10 also includes those modules in the callee IP phone 20, and the callee IP phone 20 also includes those modules in the caller IP phone 10.

The call establishing module 100 establishes the conference call with the plurality of callee IP phones 20 until the caller IP phone 10 has no available audio mixing capacity. The number of the callee IP phones is limited to the caller IP phone 10. If the caller IP phone 10 supports a 3-party conference call, the number of the callee IP phones is 2. After establishing the conference call with two callee IP phones 20, the caller IP phone 10 has no available audio mixing capacity.

When the new callee IP phone 30 is to join the conference call, the capacity selecting module 102 selects one of the callee IP phones 20 having available audio mixing capacity in the conference call. The call transferring module 104 transmits a selection message to the selected one of the callee IP phones 20 to make the selected callee IP phone 20 to mix audio line of the new callee IP phone 30.

Then, the capacity employing module 204 of the selected callee IP phone 20 receives the selection message indicating that the available audio mixing capacity is selected by the caller IP phone and then mixes audio line of the new callee IP phone 30 to accept the new callee IP phone 30 joining the conference call. In detail, the selection message includes an internet protocol address of the new callee IP phone 30, and the capacity employing module 204 of the selected callee IP phone 20 mixes audio line of the new callee IP phone 30 according to the internet protocol address of the new callee IP phone 30.

In one embodiment, to select one of the callee IP phones 20 having available audio mixing capacity, the capacity selecting module 102 establishes a table to record the other IP phones and corresponding available audio mixing capacity. Each of the callee IP phones 20 sends a notification to the caller IP phone 10 when the available audio mixing capacity of the callee IP phones 20 are changed. Here, the change of the available audio mixing capacity includes increase and decrease of the available audio mixing capacity.

Then, the caller IP phone 10 updates the table according to the notification of each of the callee IP phones 20 to record the change of the available audio mixing capacity of the callee IP phones 20. Therefore, the available audio mixing capacity corresponding to the callee IP phones 20 are recorded in the table. The caller IP phone 10 queries the table to select one of the callee IP phones 20 having available audio mixing capacity when the new callee IP phone 30 is to join the conference call but the caller IP phone 10 has no available audio mixing capacity.

For example, if the callee IP phone can support a 3-party conference at most, the available audio mixing capacity can be originally recorded in the table using 2. If the callee IP phone 20 answers the call from the caller IP phone 10 to join the conference call, that is, the available audio mixing capacity of the callee IP phone 20 is decreased, the available audio mixing capacity corresponding to the callee IP phone 20 can be recorded in the table using 1.

The caller IP phone 10 queries the table to select one of the callee IP phones 20 whose available audio mixing capacity is recorded using 1. Then, the selected callee IP phone 20 accepts the new callee IP phone 30 joining the conference call. Then, the available audio mixing capacity of the selected callee IP phone 20 is decreased, and the available audio mixing capacity corresponding to the selected callee IP phone 20 may be recorded in the table using 0. That is, the selected callee IP phone 20 has no available audio mixing capacity.

If the new callee IP phone 30 leaves the conference call, the available audio mixing capacity of the selected callee IP phone 20 is increased, and the available audio mixing capacity corresponding to the selected callee IP phone 20 may be recorded in the table using 1. That is, the selected callee IP phone 20 has available audio mixing capacity again.

In another embodiment, to select one of the callee IP phones 20 having available audio mixing capacity, the capacity selecting module 102 broadcasts a capacity inquiring message to the callee IP phones 20 in the conference call when the new IP phone 30 is to join the conference call but the caller IP phone 10 has no available audio mixing capacity. The callee IP phones 20 detects the available audio mixing capacity of the callee IP phones 20 after receiving the capacity inquiring message from the caller IP phone 10 and responds the detected available audio mixing capacity to the caller IP phone 10. The capacity selecting module 102 selects one of the callee IP phones 20 having available audio mixing capacity according to the responding of the callee IP phones 20.

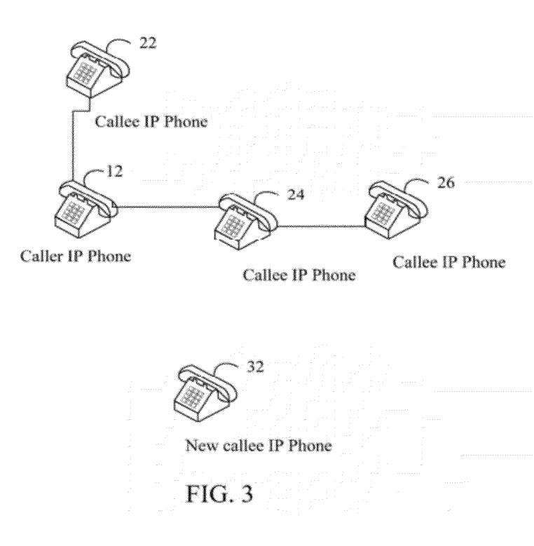

Hereafter using FIG. 3 giving an example application environment to explain how the caller IP phone 10 selects one of the callee IP phones 20 having available audio mixing capacity in the another embodiment.

For example, one caller IP phone 12, three callee IP phones 22, 24, 26, and one new callee IP phone 32 can support a 3-party conference at most. The caller IP phone 12 establishes a conference call with the callee IP phones 22, 24. The callee IP phone 24 accepts the callee 26 joining the conference call using the audio mixing capacity of the callee IP phone 24. Both of the caller IP phone 12 and the callee IP phone 24 have no available audio mixing capacity. The callee IP phones 22, 26 have available audio mixing capacity.

When the new callee IP phone 32 is to join the conference, the capacity selecting module 102 of the caller IP phone 12 transmits the inquiring messages to the callee IP phones 22, 24, 26 to inquire if the callee IP phones 22, 24, 26 have available audio mixing capacity. Then, the capacity notifying module 202 of the callee IP phone 22, 26 notifies the caller IP phone 12 that the callee IP phone 22, 26 has available audio mixing capacity. The capacity notifying module 202 of the callee IP phone 24 notifies the caller IP phone 12 that the callee IP phone 24 has no available audio mixing capacity. Then, the caller IP phone 12 knows the callee IP phone 22, 26 have available audio mixing capacity and selects the callee IP phone 22 or the callee IP phone 26 to mix audio for accepting the new callee IP phone 32 joining the conference call.

Therefore, the caller IP phone 10 can establish the conference call with the new callee IP phone 30 even though the caller IP phone 10 has no audio mixing capacity.

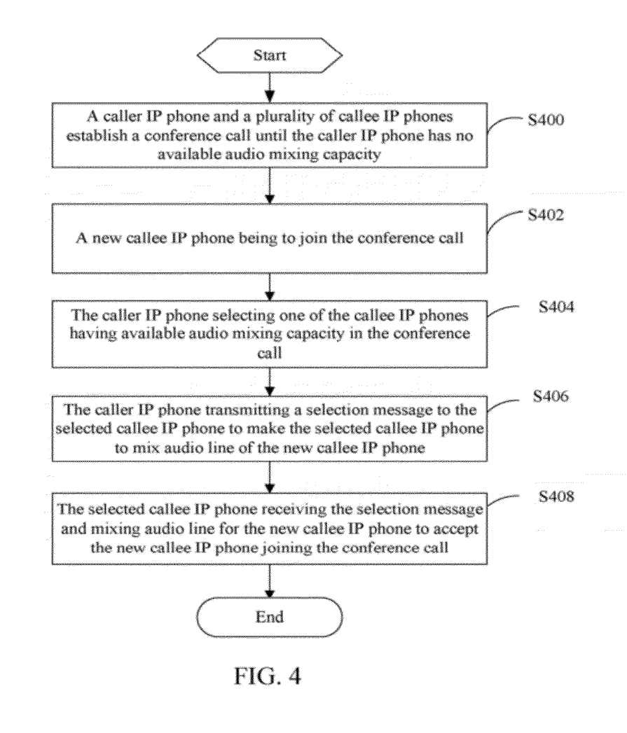

FIG. 4 is a flowchart of one embodiment of a conference call establishing method of the present disclosure. The method may be embodied in the caller IP phone 10 and the callee IP phones 20 of FIG. 1 and is executed by the functional modules such as those of FIG. 2.

In block S400, the caller IP phone 10 and a plurality of callee IP phones 20 establish a conference call until the caller IP phone 10 has no available audio mixing capacity. In detail, the call establishing module 100 of the caller IP phone 10 calls the callee IP phones 20 to establish the conference call until the caller IP phone 10 has no available audio mixing capacity. The call answering module 200 of the callee IP phones 20 answers the call to join the conference call. For example, when the caller IP phone 10 supporting a 3-party conference has established a conference call with two callee IP phones 20, then the caller IP phone 10 has no available audio mixing capacity.

In block S402, the new callee IP phone 30 is to join the conference call. In block S404, the capacity selecting module 102 of the caller IP phone 10 selects one of the callee IP phones having the available audio mixing capacity in the conference call. In block S406, the call transferring module 104 of the caller IP phone 10 transmits a selection message to the selected callee IP phone 20 to make the selected callee IP phone 20 to mix audio line of the new callee IP phone 30.

In block S408, the capacity employing module 204 of the selected callee IP phone 20 receives the selection message and then mixes audio line of the new callee IP phone 30 to accept the new callee IP phone 30 joining the conference call. In detail, the selection message includes an internet protocol address of the new callee IP phone 30, and the capacity employing module 204 of the selected callee IP phone 20 mixes audio line of the new callee IP phone 30 according to the internet protocol address of the new callee IP phone 30.

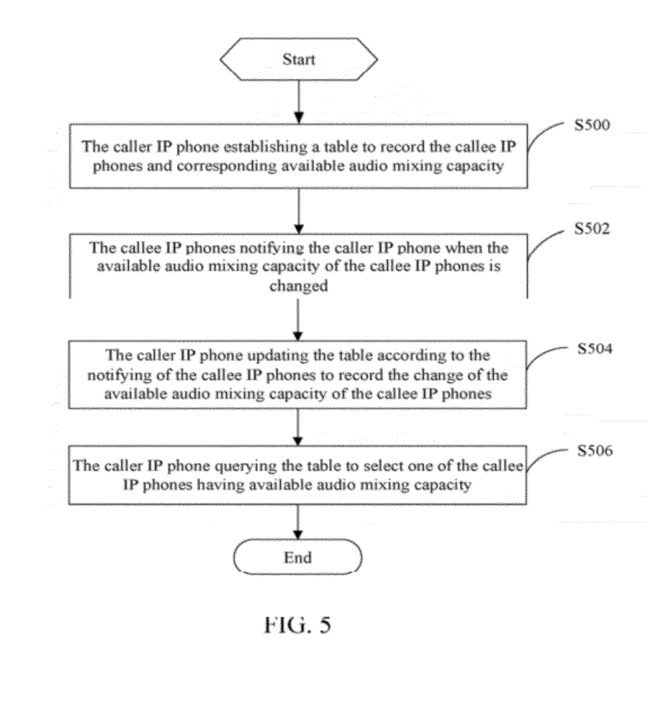

FIG. 5 is a flowchart of one embodiment of step S404 of the caller IP phone selecting one of the callee IP phones 20 having available audio mixing capacity of FIG. 4. In block S500, the capacity selecting module 102 of the caller IP phone 10 establishes a table to record the callee IP phones 20 and corresponding available audio mixing capacity. In block S502, the capacity notifying module 202 of the callee IP phones 20 sends a notification to the caller IP phone 10 when the available audio mixing capacity of the callee IP phones 20 are changed.

In block S504, the capacity selecting module 102 of the caller IP phone 10 updates the table according to the notification of the callee IP phones 20 to record the change of the available audio mixing capacity of the callee IP phones 20. In block S506, the caller IP phone 10 queries the table to select one of the callee IP phones 20 having available audio mixing capacity.

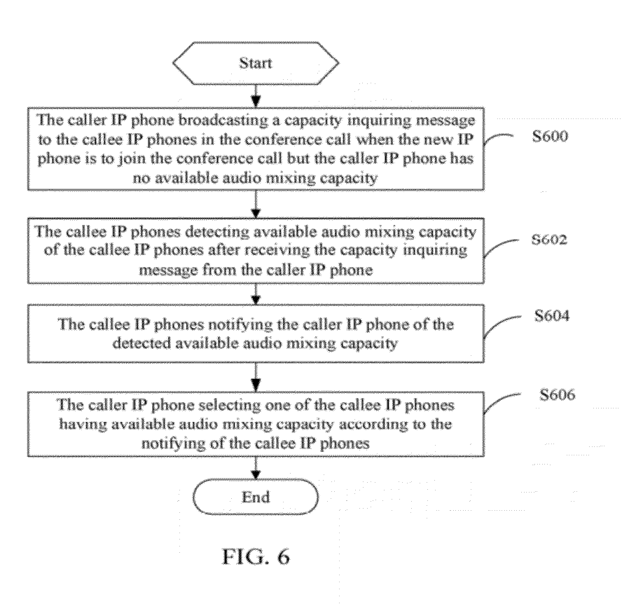

FIG. 6 is a flowchart of another embodiment of step S404 of the caller IP phone selecting one of the callee IP phones 20 having available audio mixing capacity of FIG. 4. In block S600, the capacity selecting module 102 of the caller IP phone 10 broadcasts a capacity inquiring message to the callee IP phones 20 in the conference call when the new callee IP phone 30 is to join the conference call but the caller IP phone 10 has no available audio mixing capacity.

In block S602, the capacity notifying module 202 of the callee IP phones 20 detects the available audio mixing capacity of the callee IP phones 20 after receiving the capacity inquiring message from the caller IP phone 10. In block S604, the capacity notifying module 202 of the callee IP phones 20 responding the detected available audio mixing capacity to the caller IP phone 10. In block S606, the capacity selecting module 102 of the caller IP phone 10 selects one of the callee IP phones 20 having available audio mixing capacity according to the responding of the callee IP phones 20.

The conference call establishing method of the IP phones of the present disclosure selects one of the IP phones having available audio mixing capacity to establish the conference call. That is, even when the caller IP phone 10 has no available audio mixing capacity, the new callee IP phone 30 can also join the conference call if the callee IP phones 20 have available audio mixing capacity. Therefore, the conference call establishing method of the present disclosure can overcome the limitation of audio mixing capacity of the IP phones without improving hardware for audio mixing capacity.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. An internet protocol (IP) phone, comprising:
a processor; and
a storage system storing one or more programs that are executed by the processor, the one or more programs comprising:
a call establishing module to establish a conference call with a plurality of other IP phones until the IP phone has no available audio mixing capacity;
a capacity selecting module to select one of the other IP phones having available audio mixing capacity in the conference call when a new IP phone is to join the conference call but the IP phone has no available audio mixing capacity; and
a call transferring module to transmit a selection message to the selected one of the other IP phones to make the selected one of the other IP phones to mix audio line of the new IP phone to accept the new IP phone joining the conference call.

2. The IP phone as claimed in claim 1, wherein the capacity selecting module establishes a table to record the other IP phones and corresponding available audio mixing capacity.

3. The IP phone as claimed in claim 2, wherein the capacity selecting module receives notifications indicating change of available audio mixing capacity from the other IP phones and updates the table according to the notification.

4. The IP phone as claimed in claim 3, wherein the capacity selecting module queries the table to select one of the other IP phones having available audio mixing capacity when the new IP phone is to join the conference call but the IP phone has no available audio mixing capacity.

5. The IP phone as claimed in claim 1, wherein the capacity selecting module broadcasts a capacity inquiring message to the other IP phones in the conference call to inquire available audio mixing capacity when the new IP phone is to join the conference call but the IP phone has no available audio mixing capacity.

6. The IP phone as claimed in claim 5, wherein the capacity selecting module receives responding messages from the other IP phones in the conference call, and selects one of the other IP phones having available audio mixing capacity according to the responding messages.

7. The IP phone as claimed in claim 1, wherein the selection message comprises an internet protocol address of the new IP phone to make the selected one of the other IP phones mix audio line of the new IP phone according to the internet protocol address.

8. An internet protocol (IP) phone, comprising:
a processor; and
a storage system storing one or more programs that are executed by the processor, the one or more programs comprising:
a call answering module to answer a calling from a caller IP phone to join a conference call;
a capacity notifying module to detect available audio mixing capacity of the IP phone, and to notify the caller IP phone of the detected available audio mixing capacity; and
a capacity employing module to receive a selection message indicating that the available audio mixing capacity is selected by the caller IP phone when a new IP phone is to join the conference call but the caller IP phone has no available audio mixing capacity, and to mix audio line of the new IP phone to accept the new IP phone joining the conference call.

9. The IP phone as claimed in claim 8, wherein the capacity notifying module notifies the caller IP phone upon the condition that the available audio mixing capacity is changed after joining the conference call.

10. The IP phone as claimed in claim 8, wherein the capacity notifying module detects the available audio mixing capacity of the IP phone after receiving a capacity inquiring message to inquire available audio mixing capacity from the caller IP phone, and responding the detected available audio mixing capacity to the caller IP phone.

11. The IP phone as claimed in claim 8, wherein the selection message comprises an internet protocol address of the new IP phone, and the capacity employing module mixes audio line of the new IP phone according to the internet protocol address.

12. A conference call establishing method, comprising:
a caller IP phone and a plurality of callee IP phones establishing a conference call until the caller IP phone has no available audio mixing capacity;
the caller IP phone selecting one of the callee IP phones having the available audio mixing capacity in the conference call when a new callee IP phone is to join the conference call; and
the caller IP phone transmitting a selection message to the selected callee IP phone to make the selected callee IP phone to mix audio line of the new callee IP phone to accept the new callee IP phone joining the conference call.

13. The conference call establishing method as claimed in claim 12, wherein the caller IP phone selecting one of the callee IP phones having available audio mixing capacity comprises: the caller IP phone establishing a table to record the callee IP phones and corresponding available audio mixing capacity.

14. The conference call establishing method as claimed in claim 13, wherein the caller IP phone selecting one of the callee IP phones having available audio mixing capacity further comprises: at least one of the callee IP phones sends a notification to the caller IP phone when the available audio mixing capacity of the at least one of the callee IP phones is changed.

15. The conference call establishing method as claimed in claim 14, wherein the caller IP phone selecting one of the callee IP phones having available audio mixing capacity further comprises: the caller IP phone updating the table according to the notification of the callee IP phones to record the change of the available audio mixing capacity of the callee IP phone.

16. The conference call establishing method as claimed in claim 15, wherein the caller IP phone selecting one of the callee IP phones having available audio mixing capacity further comprises: the caller IP phone querying the table to select one of the callee IP phones having available audio mixing capacity.

17. The conference call establishing method as claimed in claim 12, wherein the caller IP phone selecting one of the callee IP phones having available audio mixing capacity comprises: the caller IP phone broadcasting a capacity inquiring message to the callee IP phones in the conference call when the new callee IP phone is to join the conference call but the caller IP phone has no available audio mixing capacity.

18. The conference call establishing method as claimed in claim 17, wherein the caller IP phone selecting one of the callee IP phones having available audio mixing capacity further comprises:
the callee IP phones detecting the available audio mixing capacity of the callee IP phones after receiving the capacity inquiring message from the caller IP phone; and
the callee IP phones responding the detected available audio mixing capacity to the caller IP phone.

19. The conference call establishing method as claimed in claim 18, wherein the caller IP phone selecting one of the callee IP phones having available audio mixing capacity further comprises: the caller IP phone selecting one of the callee IP phones having available audio mixing capacity according to the responding of the callee IP phones.

20. The conference call establishing method as claimed in claim 12, wherein the selection message comprises an internet protocol address of the new callee IP phone, and the selected callee IP phone mixes audio line of the new callee IP phone according to the internet protocol address.
